(19) United States
(12) Patent Application Publication
(10) Pub. No.: US 2008/0127331 A1
(43) Pub. Date: May 29, 2008

(54) Method, system, and apparatus for linked personas authenticator

(76) Inventors: Glenn Robert Seidman, Woodside, CA (US); Joseph Edward Snyder, Palo Alto, CA (US)

Correspondence Address: Dr. Glenn R. Seidman, 830 West California Way, Woodside, CA, 94062, US

(21) Appl. No.: 11/527,896

(22) Filed: Sep. 26, 2006

(51) Int. Cl. H04L 9/32; G06F 21/02

(52) U.S. Cl. 726/21; 380/277

(57) ABSTRACT

The present invention advantageously provides the ability to link one or more personas in order to authenticate that they are the same electronic persona, real person, or real world non-person entity such as a corporation, organization, or computer process. Additionally, embodiments of the present invention facilitate the collection and validation of one or more Attributes of some or all linked personas. In particular, the present invention employs a novel software subsystem and snail-mail procedure that links a real person's Attributes in order to authenticate the link to declared associated one or more electronic personas. The software that performs the authentication is embodied as a Linked Personas Authenticator and associated subsystems and files associated therewith.

### BACKGROUND OF THE INVENTION

1. Field of the Invention

The present invention pertains to electronic authentication techniques employed within Internet social networking and commerce.

2. Description of the Related Art

There are many websites providing an electronic community providing the means for persons with common interests to interact with each other electronically. Simple websites may advertise email addresses for persons to exchange email, while more sophisticated social websites manage user accounts as well as the messaging between user accounts. In both cases, a person can often publish information about them in order to develop an electronic persona or even market themselves to meet others. This last case is typical with websites where the purpose is dating. The problem with all of these websites is that the electronic persona created by the real person behind a user account or page is not authenticated to be correct, accurate, or truthful. There have even been plenty of news articles showing that some persons have created entirely false electronic personas intended to deceive. Information and pictures were exchanged in such cases that were not even similar or close to the truth. Where the Internet is supposed to be a vehicle to facilitate information exchange, it also becomes highly dangerous due to the ease of creating a false persona.

The only means available today for authenticating a person's personal information about themselves are by presenting a government issued identification card such as a driver's license or other government issued identification card. In this case, the process to establish and authenticate the person's information was realized via a labor intensive process involving the person presenting themselves in person at a government office and having a picture taken. The person must also present additional credentials such as a birth certificate. A third party, the government which is a trusted source, validates the person's information. This is then followed by the identification card being snail-mailed to the person's stated address. The only way for the person to obtain the card authenticating them for further interaction in society is to be at the stated snail mail address. In this case, a labor intensive process achieves authenticating a person's photograph, sex, height, weight, hair color, eye color, and snail mail address. The whole process takes weeks and typically months to get the identification card.

An additional issue to understand with respect to authenticating evidence such as identification cards is that many professional criminals fake them. However, an important concept to understand with authenticating evidence is that it is important to make them as difficult to fake as possible. The more difficult they are to fake, the more credibility they have even though people know that they can ultimately be faked. An important concept in authenticating information about a person is to show as many independent sources as possible as sources of information about a person. By organizing multiple independent sources of information, it is recognized that the difficulty to fake a lot of independent correlating information is very difficult.

Clearly, social networking websites where the ultimate goal is to physically meet a person would benefit from authentication of some or all of this same information to authenticate basic information about a person's declared associated electronic persona. However, there is currently no means provided for validating this information over the Internet since driver's license cannot be presented in person electronically. Sending a driver's license electronically means that the driver's license image is stored electronically which suggests that it could be easily altered via photograph editing software.

In general, it is difficult and takes a long time to establish a new reputation on a new website at the moment that a person becomes a new member of the website and community represented there. This is particularly frustrating when a good reputation is already established somewhere else with a different user id at a distinct other website community. While a person could declare that they are the electronic persona with a specific user id at the other website community, there is no way to prove it.

In light of the above, there is a need for methods and apparatus for the ability to authenticate the linkage of multiple electronic personas, and in particular, representing the same real persona as well as authenticate the personal Attributes of the real persona over the Internet electronically with an expedient process.

### SUMMARY OF THE INVENTION

Embodiments of the present invention advantageously provide the ability to link one or more personas in order to authenticate that they are the same electronic persona, real person, or real world non-person entity such as a corporation, organization, or computer process. Additionally, embodiments of the present invention facilitate the collection and validation of one or more Attributes of some or all linked personas. In particular, the present invention employs a novel software subsystem and snail-mail procedure that links a real person's Attributes in order to authenticate the link to declared associated one or more electronic personas. The software that performs the authentication is embodied as a Linked Personas Authenticator and associated subsystems and files associated therewith.

### BRIEF DESCRIPTION OF THE FIGURES

FIG. 1 illustrates the Linked Personas Authenticator with internal subsystems shown.

FIG. 2 illustrates the Persona Services Manager with internal subsystems shown.

FIG. 3 illustrates the core ERD for the repository depicting primarily the Users table and its relationship to other tables.

FIG. 4 illustrates the unique persona identifier with the two components that comprise it.

FIG. 5 illustrates the ERD for the PersonaLinks table and the associated tables it joins with depending on personaType.

FIG. 6 illustrates the ERD for the Referrals table.

FIG. 7 illustrates the ERD for the Security Manager tables.

FIG. 8 illustrates the simple one table ERD for the Audit Trail.

FIG. 9 illustrates the Linked Personas Authenticator with authentication process for ELECTRONIC personas performed via trusted source as a third party website.

FIG. 10 illustrates the Linked Personas Authenticator with authentication process for REAL personas performed via trusted source as postal service snail-mail on the forward and return leg of the trip.

FIG. 11 illustrates the personal barcode identifier page that arrives via snail-mail.

FIG. 12 illustrates the authentication page that must be sent back via snail-mail.

FIG. 13 illustrates the Linked Personas Authenticator with authentication process performed for REAL personas performed via trusted source as postal service snail-mail on the forward leg and as internet upload on the return leg of the trip.

FIG. 14 illustrates a Face-card.

### DETAILED DESCRIPTION

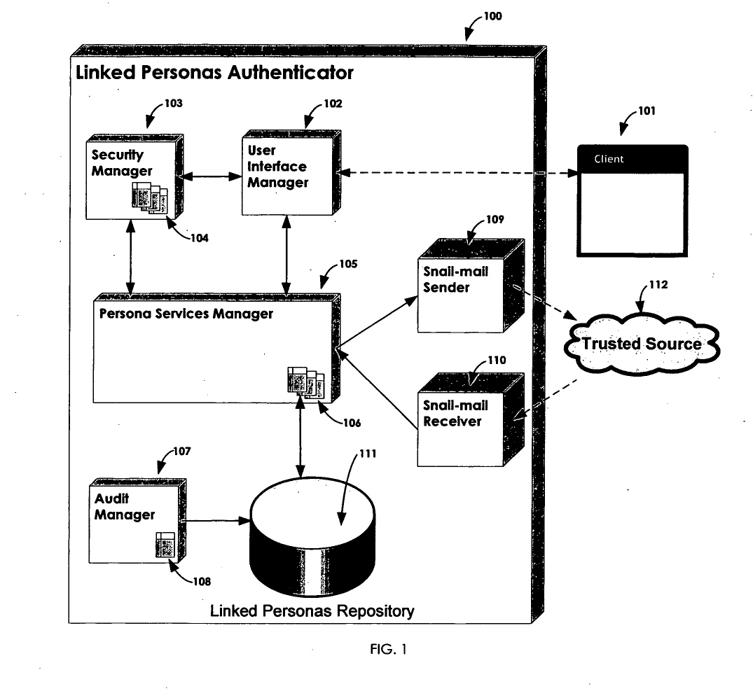

In accordance with one embodiment of the present invention is a Linked Personas Authenticator 100 in FIG. 1, with internal and related software subsystems depicted as 101 through 111. The Linked Personas Authenticator 100 interacts with a user employing a web browser 101 as well as via some messaging infrastructure to contact a person located and known by a third-party trusted source 112 as part of an authentication process for the person at the third-part trusted source. The messaging infrastructure employed is selected based on the authentication process required. The embodiment incorporates a User Interface Manager 102 for serving up user interaction screens; a Security Manager 103 for managing user accounts with associated unique user id's as well as user privileges; a Persona Services Manager 105 for providing a variety of operations and activities that users may request through the user interface; an Audit Manager 107 for storing records of all salient activities and subsequently searching them; a Snail-mail sender 109 for outputting printable pages to be snail-mailed; a Snail-mail receiver 110 for receiving snail-mailed envelopes and scanning them into the system; and a Linked Personas Repository 111 which the set of tables in a local database stores all user information, and information related to user activities. As depicted; the Linked Personas Repository 111 maintains the tables supporting the various subsystems. Within this repository, several tables 104 store user and security information; several tables 106 store information in support of the various persona services; one Audit Trail table 108 stores audit records. Note that the non-connected input arrow to the Audit Manager 107 denotes that any or all subsystems depicted may employ the Audit Manager 107. Those familiar with the art will recognize the need for the User Interface Manager 102 to operate over a secure encrypted channel, for example, utilizing SSL.

One embodiment of the present invention implements the User Interface Manager 102 as a collection of Java Servlets. These Java Servlets provide the visual elements of the user interface while invoking Persona Services for performing the actual processing. Those familiar with the art of GUI development will realize that several web-based approaches for facilitating the development of the serving of web-based user interface pages are available, and also realize that several approaches for the development of client application based user interfaces are available. Note that a client-server based embodiment may implement the user interface in a client installed application running on the client machine and avoid the use of web processing.

One embodiment of the present invention employs the Security Manager 103 to provide services for adding a user account, deleting a user account, maintaining the passwords for each user account, as well as establishing and enforcing user privileges to specific data stored in the repository. The storage of this information is maintained in the Security Manager tables 104. Embodiments of the Linked Personas Authenticator 100 may employ a special Administrator account to add user accounts, but typically users themselves should be able to request creation of a new user account for themselves.

One embodiment of the present invention implements the Snail-mail sender 109 as submitting a snail-mail address associated with an electronic document to an external service that provides the service of receiving this information in order to print out the document, put it in an envelope, and snail-mail it to the associated address. This external service provides the benefit of being able to send snail-mail totally electronically from the perspective of the software that embodies the present invention. For example, L-mail provides such a service and is located at www.l-mail.com. Note that a less modern embodiment may employ a real person to actually be given printed pages with an associated snail-mail address. Such a person represents the implementation of the snail-mail sender and is required to fold the printed pages, insert them in an envelope, and affix an associated printed sticker of the snail-mail address to the envelope.

One embodiment of the present invention implements the Snail-mail receiver 110 as receiving already scanned electronic documents from an external service that receives snail-mail with documents that must be input into the software that embodies the present invention. Such an external service does not appear to be available but if it were available, an embodiment may utilize this as a modern approach for inputting incoming snail-mailed documents. Note that a less modern embodiment may employ a real person to actually receive incoming snail-mail envelopes. Such a person represents the implementation of the snail-mail receiver and is required to open the received snail-mailed envelopes, remove the pages, and then scan the pages into the software that embodies the present invention. An important responsibility of the Snail-mail receiver 110 is to scan one or more graphic marks, typically barcodes, within the page images that represent salient identifiers in the Linked Personas Authenticator 100 processes. Software that reads bitmap images, finds barcodes and determines their numerical values is available. See www.bardecode.com for software such as Softek Barcode Reader Toolkit that provides this capability.

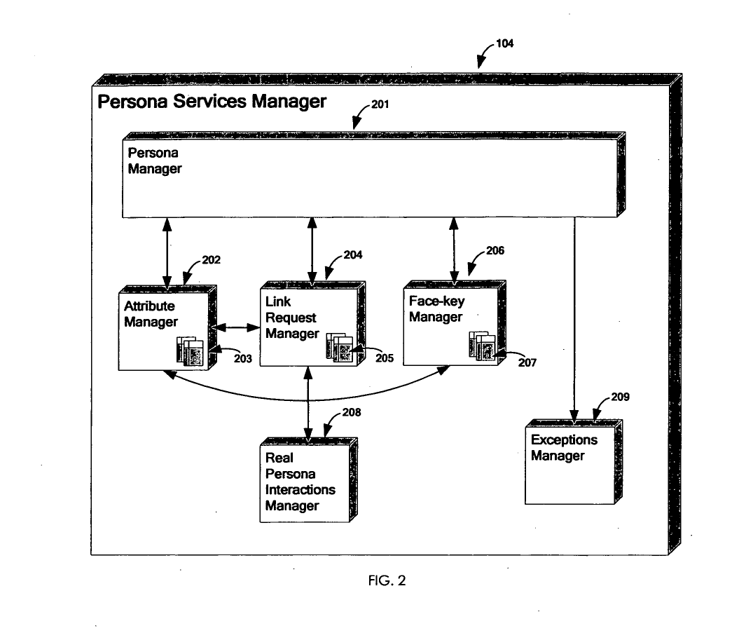

With reference to FIG. 2, a Persona Services Manager provides the implementation of requested user operations and activities initiated from various pages of the User Interface Manager. The Attribute Manager 202 provides storage of user information including information about which Attributes have been authenticated. The key or Face-key Manager 206 provides creation and deletion of keys as well as information about which specific information is accessible by each key. A Face-key represents a published “face” of a user in that it provides access to view specific user Attributes and represents a key in that it only provides access to a user or users that have been provided a specific Face-key. The Link Request Manager 204 processes a user's request to link one's user id to an external persona. Such a request may link the user's user id with a real persona and or such a request may link the user's user id with the user id of a distinct other website. When a link request is for linking the user id to a real persona, the Real Persona Interactions Manager 208 is used. In this case, the Real Persona Interactions Manager 208 is employed to create printable pages intended to be snail-mailed via the Snail-mail Sender 109. When pages are received via the Snail-mail Receiver 110, Real Persona Interactions Manager 208 performs an electronic scan of the received pages in order to process them as expected.

One embodiment of the present invention has a Link Request Manager 204 that employs generation of unique persona link identifiers 401 that are used to correlate sent out requests with subsequent responses as well as which user id a link request is associated with. When the request is ultimately to a user's snail-mail mailbox, the Real Persona Interactions Manager 208 will print the persona link identifier 401 to the printed pages to be sent out in the form of an easy to scan graphic mark such as a barcode. When pages are received via the Snail-mail receiver 110 and then the Real Persona Interactions Manager 208, the pages are assumed to contain a graphical representation of a graphic mark that may essentially be scanned entirely electronically to determine the unique persona link identifier. Using the unique persona link identifier, the Link Request Manager 204 can look up the originally sent out request to determine which user the incoming documents are associated with. When the request is ultimately to an electronic destination, then the generation of the graphic mark is not necessary and the unique persona link identifier may be maintained easily in an email or HTTP request in a precise numerical form.

As with any complex software system, problems will occur. The Exception Manager 210 is available for all subsystems to log exceptions and subsequently notify the appropriate user or users. One example of an exception that may occur is a received transaction identifier with no match in the previously generated transactions maintained by the Link Request Manager 204. Such a non-match might occur because the graphic mark image quality has been comprised or because someone is trying to circumvent the authentication process by sending in a page with a cleverly modified transaction identifier or entirely manufactured identifier. Another example of an exception is when information on the page doesn't meet certain standards or criteria deemed necessary to maintain the integrity of the authentication process. Many other exceptions are possible and will be stored in the Audit Trail table maintained by the Audit Manager 107. Those familiar with the art of exception processing will realize that notifications to users triggered by exceptions may be necessary via email or other means.

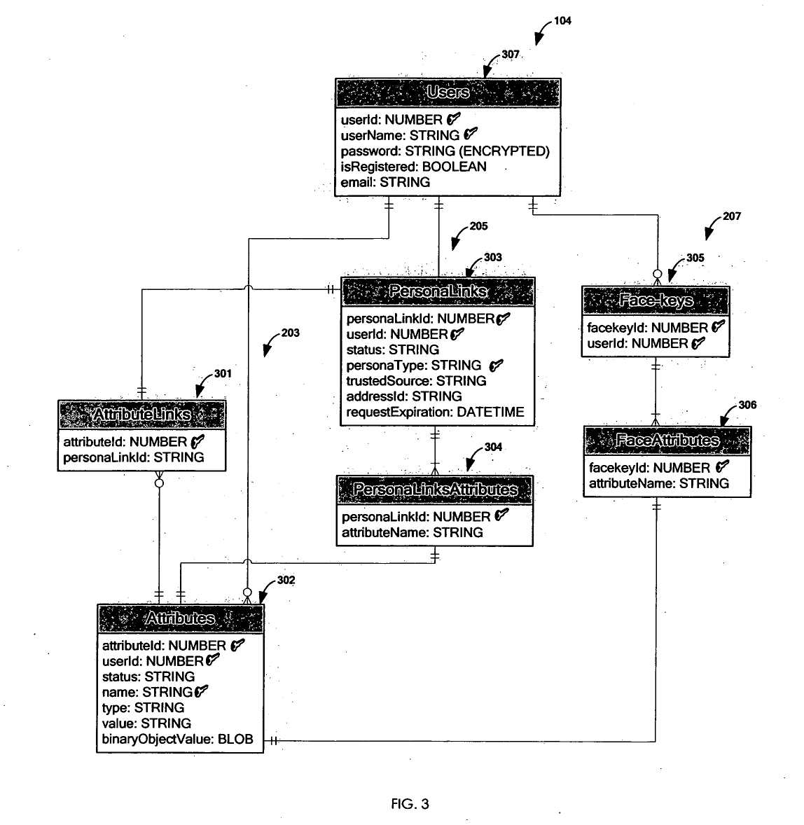

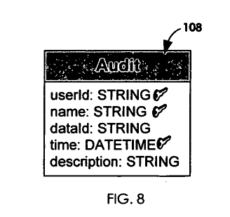

An embodiment of the present invention may persistently store all information in database tables. The collection of such tables is known as the Linked Personas Authenticator Repository 111. FIG. 3 through FIG. 8 depict the ERD diagrams for one embodiment of the invention for which the subsystems of FIG. 1 and FIG. 2. store and retrieve persistent information. With reference to the ERD of FIG. 3, each User object 104 comprises several aspects of information, namely, Attributes 302, PersonaLinks 203, and Face-keys 305. The diagram employs the key symbol to denote which fields are suggested to be indexed for faster query execution.

One embodiment of the present invention provides a home page within the User Interface Manager 102 for providing information about the purpose of the Linked Personas Authenticator 100 system and application but, in particular, provides the means for creating a new user account. When a user requests a new user account, initially a unique username and password must be selected. Once a unique username is selected, the user account record is created in the Users table 307 of FIG. 3 with a unique internal numerical userId, the userName field is populated with the supplied name, and the password is stored encrypted. The isRegistered field is set to TRUE since the user has actually established an account with the site. The email field is set by the user to an Internet email address for communicating messages to the user. It is possible that an embodiment will create a user account automatically for a user that has not registered. In this case, the isRegistered field is set to FALSE.

When a user interacts with the User Interface Manager 102, typically presented as a one or more web pages, for reading or editing their own Attributes, the Attribute Manager 202 service is employed. The Attribute Manager 202 stores user Attributes in the Attributes table 302 keyed on both a uniquely generated attributeId as well as the userId. The name and type of an Attribute is maintained along with the value of the Attribute. Either the value field or binaryObjectValue field will be used, but not both, depending on the type field. For example, a photograph will be a bitmap stored in the binaryObjectValue field. Primitive value types such as strings, numbers, and dates and times will be stored in the value field and always as a string. Depending on the type, the Attribute Manager 203 knows how to interpret the stored string correctly. The status field may be one of DECLARED, AUTHENTICATED, DECLARED.REQUEST, DECLARED.DISABLED, or AUTHENTICATED. DISABLED. DECLARED means that the user has entered the Attribute but it has no authentication. AUTHENTICATED means that the Attribute has been authenticated via a completed authentication process. The REQUEST suffix means that an authentication request has been initiated for a DECLARED Attribute but it is not completed. The DISABLED suffix means that the Attribute has been made unavailable. Each User has a unique userId which may be used to retrieve information for the specific userId. For example, all user Attributes may be retrieved via the query: SELECT*WHERE Attributes.userId=<specific userId> FROM Attributes.

One embodiment of the present invention provides the means for users to associate Attribute Folders with their user id in order to organize Attributes in a hierarchical fashion. In this case, Attributes will be accessible by a path denoting the folder path in the hierarchy and ending with the name of the Attribute.

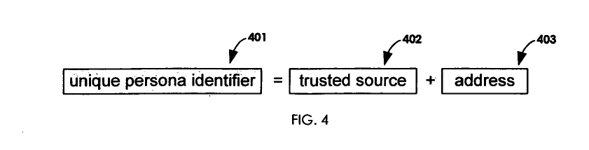

When a user requests to link their userName to a new persona (ELECTRONIC, REAL, ACCOUNT, REFERENCE, or other), the user must essentially enter a unique persona identifier that uniquely identifies the persona relative to all other personas. The unique persona identifier 401 is composed of two components as illustrated in FIG. 4. The first component is the place where the persona is known. This is known as the trusted source 402 in the present invention. The second component is a unique address 403 employed within the trusted source to distinguish the persona from other personas that reside in the same trusted source. The more respected and well-known the trusted source component is of one's linked persona, the higher the confidence that others will have that the persona is the persona that one declares and that the declared Attribute values are true. In addition to entering the unique persona identifier, a user also identifies the subset of already entered Attributes to authenticate. When the user makes such a request, the Persona Services Manager's 201 LinkRequest Manager 204 creates a PersonaLink object with a unique personaLinkId and inserts a record representing it into the PersonaLinks table 303. As shown, the creation of a PersonaLink incorporates also the insertion of one or more PersonaLinksAttribute records into the PersonaLinksAttribute table 304. When the PersonaLink is created, the status field is set to REQUEST in the record.

One embodiment provide the means for an expiration date and time to be set by the system or each persona link request. The system sets the requestExpiration field in the PersonaLink table 303 record. If the response to the request arrives after the requestExpiration date, then the link is not authenticated successfully.

Each record in the PersonaLinks table 303 has a personaType field which may contain a value of either ELECTRONIC, REAL, ACCOUNT, REFERENCE, or OBJECT. Keeping in mind that each persona is supposed to be an authenticated link to the same registered userId but having representation at a specific location; the values of the personaType field respectively correspond to a username at another website, an account at a corporation or entity, the person's real identity emphasizing their real-world snail-mail address, a validating reference by another registered user, or an object that has some relationship to the user. Note that an object persona is not really a persona at all, but rather an inanimate object that has some relationship to the user being linked. For example, this information could store an OWNED, LEASED, ACCESSIBLE, or any other relationship qualifier that would be of interest to maintain.

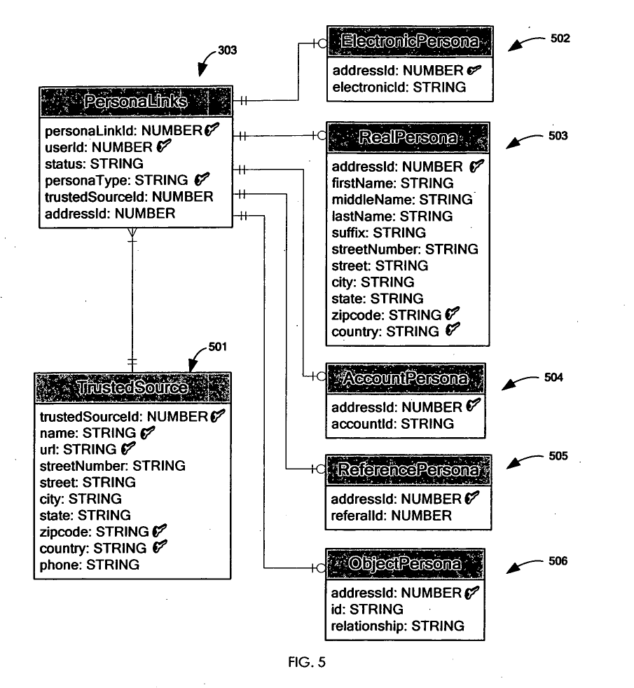

The PersonaLinks table 303 of FIG. 5 coordinates the information regarding each persona linked to userId stored in an embodiment of the present invention. Each PersonaLinks record represents one linked persona and joins with the TrustedSource table 501 on the bottom left for detailed trusted source information and one of the five tables (502-506) positioned in the right column which represent the unique identifier for a persona within the context of the denoted trusted source. The table on the right to join to is determined by the personType field in the PersonaLinks table 303 record. The personaType field values of ELECTRONIC, REAL, ACCOUNT, REFERENCE, or OBJECT correspond to one of the tables (502-506) on the right with the same name in its prefix. Together, the three joined tables form a list of unique persona identifiers each with trusted source and unique persona address components.

Each TrustedSource record must have a unique name field to distinguish it as a unique trusted source. Note that not every trusted source has a web presence so that the url field may be left NULL. As depicted in the TrustedSource table 501, snail-mail address information may be of interest to maintain for the trusted source information. Phone number may also be of interest. However, neither the snail-mail address or phone number is required. Those familiar with the art of storing contact information in a computer system will recognize that some embodiments may need to store multiple snail-mail addresses and/or phone numbers.

When the personaType field is ELECTRONIC it means that the persona to link to is a web presence. In this case, a TrustedSource record 501 is inserted and only the url field must be populated with a website address, and the electronicId field of the Electronic Persona table 502 is the username at the website.

When the personaType field is REAL, it means that the persona to link to is a real person at a snail-mail address. In this case, a TrustedSource record 501 is inserted with the name field containing “PostalService”. The corresponding RealPersona record 503 contains the user's first name, middle name, last name, suffix, and snail-mail address information. All of this information refers to a unique persona known by the postal service.

When the personaType field is ACCOUNT, it means that the persona to link to is an account at a corporation or entity in the real world. In this case, a TrustedSource record 501 is inserted with the name field populated with the unique name of the entity, and the accountId field of the AccountPersona table 504 is the account at the entitly. For example, the trusted source could be the name of a bank or credit rating service. It might even be the IRS in which case the accountId would be the social security number.

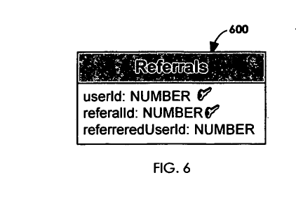

When the personaType field is REFERENCE, a TrustedSource record 501 is inserted with the name field containing a string representation of the userId of someone who has registered. The referalId field in the ReferencePersona table 505 is a sequence number that is generated per userId that is providing a referral. Thus, when a user provides a reference for another userId, the Referrals table shown in FIG. 6 has a record inserted into it with the sequence number maintained per the userId scope and stored in referalId. This referalId is associated to the userId being referred in the same record in the referredUserId field.

When the personaType field is OBJECT, a TrustedSource record 501 is inserted with the name of an entity or organization that tracks the object that can verify that the persona has a given relationship to the object (e.g. OWNED, LEASED, etc.) Any id provided by the organization is stored in the id field of the ObjectPersona table 506 record. A relationship field must also be included.

One embodiment of the present invention combines the ElectronicPersona table 502, RealPersona table 503, AccountPersona table 504, ReferencePersona table 505, and ObjectPersona table 506 into one table with an addressId field and a generic id field since paradigmatically this is what each of these tables store.

Embodiments may add additional tables to record a unique persona address in order to track persona identification that may fall into other categories.

An embodiment may employ LinkRequest templates for categorized destinations with already set Attributes for requesting authentication. For example, the LinkRequest for a real persona will likely include Attributes involving a person's physical features since a photograph Attribute is always requested. Meanwhile, a LinkRequest for an eBay persona might request no Attributes since an authenticated link to an eBay persona is sufficient for proving any Attributes that eBay stores on their website.

As illustrated in FIG. 3, the Attributes that have been chosen as part of a LinkRequest have records created in the PersonaLinkAttributes table 304 with the unique personaLinkId and the attributeName field. This identifies the specific Attributes stored in the Attributes table 302 that are associated with the LinkRequest which is a PersonaLink once the request is complete and Attributes authenticated. Note also that a join query on the personaLinkId may be performed in order to retrieve all of the Attributes that are associated with a PersonaLink.

One embodiment of the present invention employs an AttributesLink table 301 which is populated with one personaLinkId field for each PersonaLink that has completed authentication of the Attribute with unique attributeId. Since there may be zero or more of these AttributeLink records per attributeId, this beneficially maintains a record of the strength of the authentication of the Attribute.

A major advantage of the present invention is its ability to allow a user to control what Attributes about them that they want to share with another user. This is distinct from other websites such as www.linkedin.com where users may query attributes of other registered users without permission or with very easily gained permission. Instead, the present invention beneficially allows a source user to completely control which specific attributes that a destination user has permission to browse via creation and distribution of a custom made electronic key. Source users may request a Face-key to be sent to a destination user.

With reference to FIG. 3, each Face-key request comprises the userIds being granted access to the Face-key and the Attributes associated with the Face-key. Each such request inserts a new Face-key table 305 record with a unique facekeyId and the userId of the user requesting Face-key. The value of a Face-key is the Attributes that it grants permission to. One FaceAttributes table 306 record is inserted for each Attribute associated with the Face-key. Each FaceAttribute record has the unique facekeyId to the Face-key it belongs to while the attributeName field is populated with the name of the Attribute.

Since a user may desire sending a Face-key to a person who does not have an user account registered with the Linked Personas Authenticator 100 system, the system must automatically create a user account for them. The means to identify the target persons is to employ their unique email addresses. In this case, one embodiment creates a user account for each non-registered user who will be given the face-key. Since the users are not actually registered, their accounts are created but their unique usernames are set to NULL in anticipation that they may want to register and provide a unique name. In the meantime, they will still need to log in and, in this case, they use their unique email address which the Security Manager 103 knows to use when the username is NULL. The password for non-registered users to login is set by the user requesting to distribute a Face-key. The system will only ask for this password when it recognizes that target users are not registered. It is suggested that a user targeting non-registered users must tell the non-registered users who will receive their face-key what their passwords are via an alternate means such as email, snail-mail, phone, or other channel.

One embodiment provides already made Attribute Templates comprising a list of Attributes and their types that would be found useful in various Face-key scenarios. The list of Attributes would be automatically added to a Face-key for each selected Attribute Template. The embodiment also provides the means to create new and reusable Attribute Templates.

One embodiment creates self-contained Face-keys that allow viewing of the Face-key information without requiring additional software subsystems or logging into the website represented by the Linked Personas Authenticator 100. In order to achieve this securely, the embodiment encrypts the entire Face-key contents, but it does comprise executable code that guards access via username and password and presents the Attributes when a username and password pair is authenticated. The embodiment encrypts and embeds each username and password pair that has access to the Face-key. It also encrypts and embeds the list of linked personas associated with the Face-key. The embodiment also encrypts and embeds the list of Attributes associated with the Face-key.

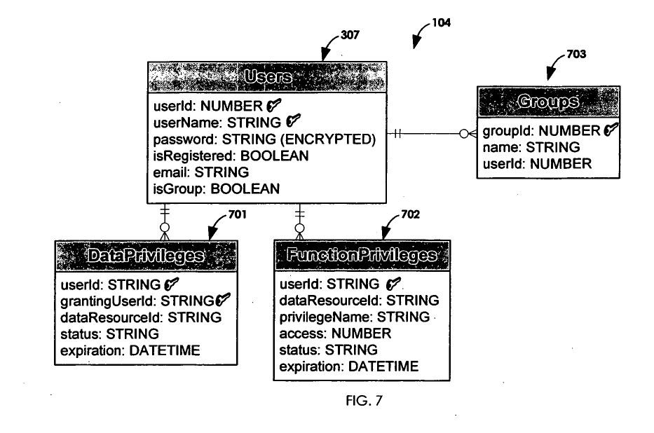

One embodiment creates Face-keys that are not self-contained but require logging into the website representing the Linked Personas Authenticator 100. The embodiment employs the Security Manager 103 to accomplish secure controlled access to the Face-key information. In this case, the Security Manager 103 is employed to actually maintain the specific userIds that have been granted Face-key permissions. FIG. 7 depicts the tables that the Security Manager maintains. When a source user requests a Face-key, each destination userId has a DataPrivileges table 701 record inserted that denotes the granted access. In this case, the graninguserId is the source userId granting permission, the dataResourceId field is the facekeyId, the status field is initially ENABLED. The source user may disable Face-key access at a future point in time through the user interface. In this case, the status field is set to DISABLED. Note that there is also an expiration field with a date and time that the access will cause the status field to be set to DISABLED. A notification will be sent to the source user who originated the Face-key when this occurs. The source user may employ at any time the user interface to re-enable access. When no expiration is selected, the expiration field is set to NULL or some other value expedient to determining that the access should not expire.

The FunctionPrivileges table 702 is also used to govern Attribute access. A FunctionPrivilege record may be inserted for each Face-key with the privilege field set to USERFACEKEY. The access field is READ, WRITE, CREATE, DELETE, or EXECUTE. These access rights are each represented with a bit position and may be ORed together. The typical use of a FunctionPrivilege for Face-key control is only to declare READ. However, more sophisticated embodiments of the present invention may see benefits in providing the means for setting the dataResourceId with a specific attributeId from the Attributes table 302 and governing WRITE, CREATE, DELETE, and EXECUTE access on specific Attributes, but likely not core authenticated Attributes. In Attribute specific control, the privilege field is set to USERATTRIBUTE.

The FunctionPrivileges table 702 may also be utilized by embodiments to govern access to function privileges other than USERFACEKEY and USERATTRIBUTE. Clearly, different embodiments will implement many different functions and make different general functions available to users based on payment options or other criteria. For example, the function to create a Face-key may be a CREATEFACEKEY privilege that is only available to users who pay for it. Basic users may have only the READFACEKEY privilege which is required to read Attributes of Face-keys received. Embodiments may implement additional privileges to govern general user access to various functions available in the system. In such cases, the dataResourceId field may remain NULL. Note that the status field and expiration field are present and operate in the same fashion as they do with the DataPrivileges table 701.

In light of the typical desire to be able to search users and by their Attributes, one embodiment maintains a special user id for the entire Linked Personas Authenticator search capability so that users can create Face-keys destined for this special search user id. In effect, the Attributes that a specific user attaches to the Face-key for the special search user represents the only subset of Attributes that the user is allowing to be searched.

It is common for users to want to be associated with groups of other users and allow only other members of the same group to have special access to their information. One embodiment implements the special search user concept on a per group basis. In this way, users may create a Face-key for each group they belong to and control what Attributes are searchable by each specific group. FIG. 7, depicts one embodiment's implementation of groups via the Groups table 703. The Groups table maintains an entry for each user and for each group that a user is in. Each record stores the groupId, the name of the group, and the userId. The groupId is employed as the userId for the purpose of denoting the user for the search Face-key for the group. In fact, one embodiment stores a record in the Users table for each group and denotes that the User is a group via the isGroup Boolean field in the Users table 307. The User Interface Manager 102 provides the means for users to create groups as well as join the groups. Those familiar with the art of user management and user groups on public websites will recognize that there are many common implementation approaches for this capability.

One embodiment of the present invention provides a special UNIVERSE group that represents everyone that could search or be sent a UNIVERSE Face-key. When a user authors a Face-key for UNIVERSE and distributes it, the recipient need not log in. The url that comes with it links directly to the associated persona link and Attribute information.

An embodiment of the present invention includes also an Audit Manager 107 with associated Audit table 108. The Audit Manager 107 is invoked to record all salient activities in the system. Whenever an occurrence is to be recorded, a record is created in the Audit table 108 inside of the transaction governing the operation it is recording for. This preserves transactional integrity of the audit trail. One embodiment of the present invention records the userId, a name for the audit record denoting an audit category to perform indexed queries on, the dataId if there is one, the date and time it occurred, and a description. The Audit history user interface is likely to be employed to query the audit by userId, by name field, and by time field.

A key aspect of the present invention is the authentication process employed to validate a persona at a third party trusted source. Each authentication process must, in fact, interact with the trusted source entity on behalf of the persona being linked and authenticated. Clearly the authentication process may vary depending on whether the trusted source is electronic or in the real world. More specifically, it depends on the personaType field of the PersonaLinks table 303. Recall that one embodiment uses values of ELECTRONIC, REAL, ACCOUNT, REFERENCE, and OBJECT for the personaType field. A description of the authentication process for each of these personaType values follows.

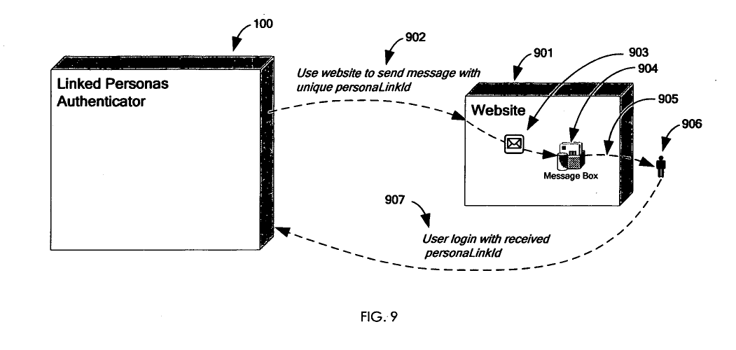

For an ELECTRONIC personaType, the authentication process involves using the trusted source to send a message 902; in this case, via the website 901, to the persona with specified electronicId as illustrated in FIG. 9. This may require that the Linked Persona Authenticator 100 subsystem have its own user account at the website. The message 903 must contain the personaLinkId of the originally requested PersonaLink so that the user can later login to the Linked Personas Authenticator system and submit the sent personaLinkId. Initially, the message with the unique personaLinkId will be received and stored in the local user's messagebox 904 at the website. Note that some websites, such as www.ebay.com use both a website managed messagebox as well as an email registered with the website. Either approach will realize valid authentication. The user opens the message 905 and sees the request to finish the back leg of the authentication process 906. They simply click the URL link on the message which will bring them to a special Linked Personas Authenticator 100 webpage where they can enter their password to complete the authentication 907. Since only the person with registered userId who requested the link will know both the username and password of the third party website and the username and password at the Linked Personas Authenticator 100 websiteF, this validates that the personas may actually be linked because they are controlled by the same person. Note that only websites offering a message sending capability that sends a message to a specific user id within the website may be used as a trusted source within an authentication process for an ELECTRONIC personaType. Embodiments should employ common techniques for beneficially storing a list of websites that facilitate authentication and those that do not.

Those skilled in the art of authenticating a user will recognize the above described technique used at many websites. However, the common utilization of the technique is when the website itself authenticates a user's email address. The authentication process description above is novel because an entity external to the website employs the website to authenticate a user known by the website.

One embodiment recognizes that many websites do not offer the ability to send a message from one user to another within the website, and instead, employs the login page using a trick. In this case, the embodiment pretends to be the other electronic id, or user id at the third part website by requesting a forgotten password for the user id. Most websites offer this service and will send an email with the password or an email offering a link to reset the password. Such websites assume that only the person with user id registered will receive the forgotten password email. When the person receives the forgotten password email from their website, they will not receive a unique personaLinkId because there is no way to send one in this scenario. Instead, the Linked Personas Authenticator 100 forgotten password email is requested at a random time in the next 24 hours. The Linked Personas Authenticator 100 remembers the time it requested the forgotten password email. The person receiving the email authenticates by logging in to the Linked Personas Authenticator 100 website and entering the date and time on the forgotten password email. Authentication is assumed to be successful if the date and time is correct within a very small time window such as a few minutes. The time window size may be configured by the system. Some websites may not send the forgotten password email right away. This can be a problem that will prevent authentication. Multiple attempts can be performed, but ultimately the website may have to be tracked and remembered as a problem website for this authentication technique.

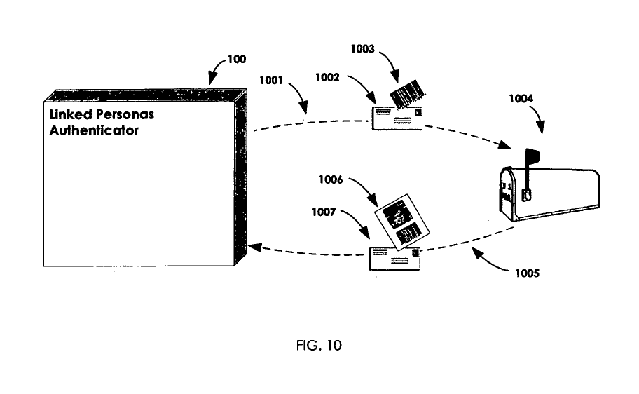

For a REAL personaType, the authentication process involves sending a snail-mail letter via the trusted source; in this case the postal service to the persona with their declared snail-mail address as illustrated in FIG. 10. The authentication process in this case emphasizes geographic location validation (1001-1007). The authentication process (1001-1007) begins when a user with user id, or real person, requests to authenticate their REAL persona via the postal service using geographic location and a photograph. When such a request is initiated, the Linked Personas Authenticator 100 produces the PersonaLinks table 303 record with unique personaLinkId normally. However, since this unique id must be sent on paper via snail-mail, a computer readable graphic representing the unique numerical value must be generated, for example, as a barcode. This personaLinkId barcode identifier 1003 is printed, placed in an envelope 1002, and snail-mailed 1001 to the user's declared geographic snail-mail mailbox 1004. Meanwhile, the Linked Personas Authenticator 100 remembers the association of the user account id with the personaLinkId in the PersonaLinks table 303. The user receives 1001 the barcode value 1003 with a letter 1002 instructing them to take a picture of themselves with the barcode clearly visible in the picture. The letter comes with a special Authentication page 1006 comprising a box to affix the photograph on the top half of the page and a copy of the barcode on the bottom half of the page already printed. The user is instructed to snail-mail back 1007 in an envelope the Authentication page to a declared snail-mail address where the information may be entered into the Linked Personas Authenticator system 100.

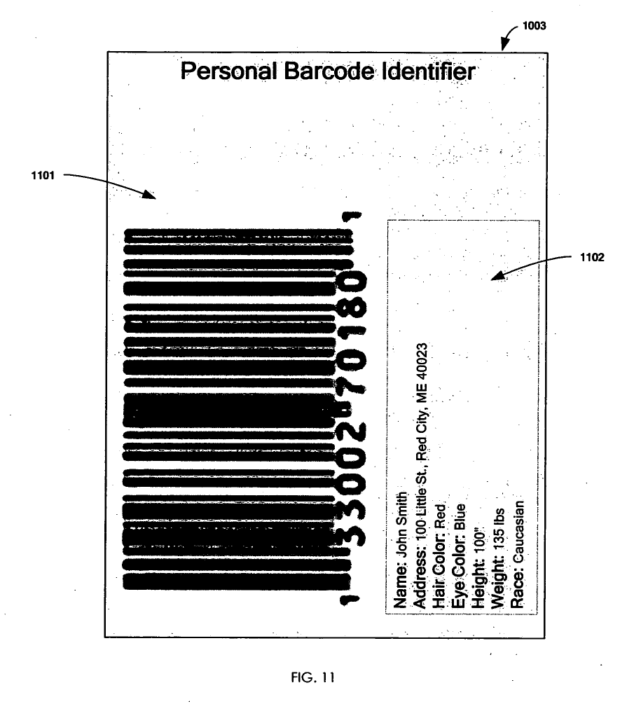

An example personal barcode identifier 1003 that arrives via snail-mail is pictured in FIG. 11. The example shows an 8½″ by 11″ sheet of paper that arrives by snail-mail representing the personal barcode identifier page 1003. The sheet printing is oriented in landscape mode. The barcode with barcode value 1101 is printed very large in the top half. For an embodiment of the present invention that requires that a user enter personal Attributes upon authentication process request initiation, the personal Attributes are printed on the bottom 1102.

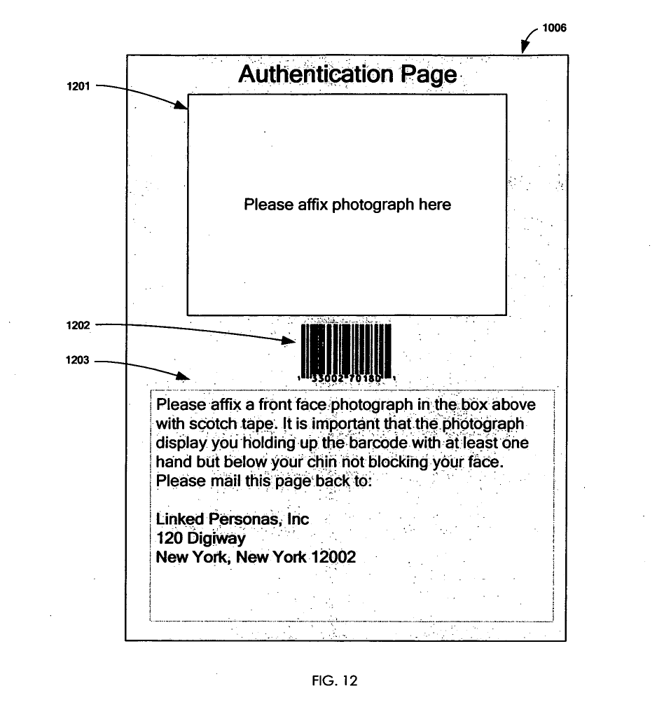

An example authentication page 1006 that arrives via snail-mail but which is to be snail-mailed back is pictured in FIG. 12. The authentication page requires that a photograph be taken and affixed to the boxed area 1201 at the top of the sheet. The same barcode with barcode value displayed 1202 is printed on the page as well. At the bottom of the sheet, are the instructions and the snail-mail address to mail the authentication page back to.

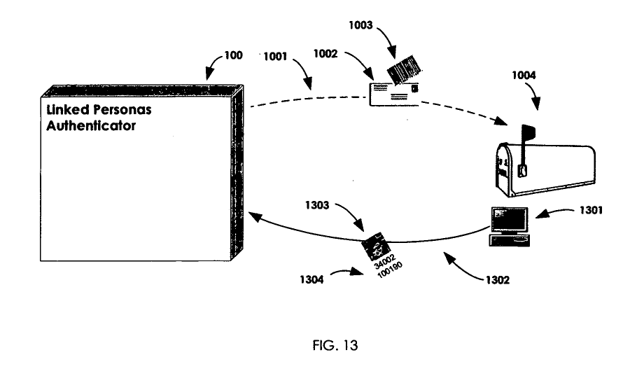

One embodiment of the present invention employs a more expedient approach (1301-1304) of providing an Authentication page back to the Linked Personas Authenticator system 100. In this approach, shown in FIG. 13, a digital photograph 1301 is collected by the user and uploaded 1302 via their computer 1301 over the web. The user may also be expected to type in the barcode value 1304 that they received in snail-mail as part of the upload process. This last step is redundant but can assist in determining what might be wrong when the uploaded digital photograph barcode cannot be read as the correct barcode value.

A preferred embodiment of the present invention works in conjunction with the successful completion of the geographic location authentication process. The returned photograph in both of the processes pictured in FIG. 10 and FIG. 13 maintains high probability that the person in the photograph lives or has access to the snail-mail address stated.

One embodiment of the present invention requires that the person in the photograph hold up the snail-mail sent barcode value with their hands. This makes it difficult to photo edit a digital image which must contain the barcode. When the authentication page is returned and then received by the Linked Personas Authenticator's 100 snail-mail receiver 110, both the barcode presented in the photograph box area 1201 and the separate personal barcode identifier 1202 must be validated as matching.

An embodiment can increase the difficulty of falsifying the associated real person photograph and Attributes by requiring additional ongoing requirements. One approach that increases difficulty of falsifying incorporates periodic snail-mailed barcode values sent to an address requiring an updated photograph with sent barcode value to be returned. Another approach that increases difficulty of falsifying is to employ a tracked snail-mail process that records the date and time that a person receives the snail-mail. The process could then require that the real person return the photograph with sent barcode value within a certain amount of time. This will have the affect of giving deceivers less time to set something up with another person. For example, certified snail-mail or federal express can be employed. When employing upload of a photograph, one approach employs an IP address to geographic location mapping database to verify that the geographic location of the uploading IP address is consistent with the user's declared snail-mail address.

Another embodiment requires that a real person provide physical attribute information at the point that they request to initiate the authentication process. One approach is to request physical attribute information about height, weight, hair color, eye color, skin color, build, etc. Another approach is to require a photograph to be uploaded. Both approaches make it difficult for a deceiver to correlate physical attribute information at two distinct points in time; the first being at authentication process initiation time and the second being at snail-mail barcode value reception time. It also prevents a deceiver from changing the physical Attributes to publish between request initiation and the time that the photograph with the barcode value is taken.

One embodiment of the present invention provides the means for a user account to declare any number of Attributes about their associated real person that will be stored. Zero or more of these Attributes may be non-authenticated while one or more Attributes are expected to be authenticated by the authentication process and the stored associations within the Linked Personas Authenticator 100.

For an ACCOUNT personaType, the authentication process takes on various approaches but cooperation is required from the trusted source; in this case a real world entity or corporation. When the REAL personaType has already been authenticated, all that is necessary is verifying the name and snail-mail address for the account at the entity or corporation. This may be performed via a phone call or by sending a snail-mail letter requesting the information. This will either prove or disprove that the account belongs to the same person. When the REAL personaType has not been authenticated, such a phone call or snail-mail letter must be sent to the trusted source entity to request the name and snail-mail address information. This snail-mail address information may then be used in the same REAL personaType authentication process of FIG. 10.

For a REFERENCE personaType, the authentication process involves sending an email to another registered userId requesting that they authenticate the userId requesting the reference. In this case, the requesting user will be provided the means via the user interface 102 to insert a short message identifying themselves so that the user to provide the reference is assured who it is. The user interface will also provide the means to include a Face-key for further verification. The user that is being asked to provide a reference receives a message with the unique personaLinkId just like all other authentication requests. Just as with the ELECTRONIC personaType, the message contains an URL link that takes the user to a special page where they must login to authenticate. Instead of authenticating themselves, the user providing the reference authenticates the requester with the personaLinkId provided.

For an OBJECT personaType, those familiar with the art will recognize that a variation on either the ELECTRONIC personaType authentication process or the REAL personaType authentication process must be performed to validate that the OBJECT has a specific relationship to the user. The authentication process will be selected based on whether the trusted source has a strong and facilitating website or operates more in the real world as an entity, organization, or corporation that maintains accounts or identifiers for specific items.

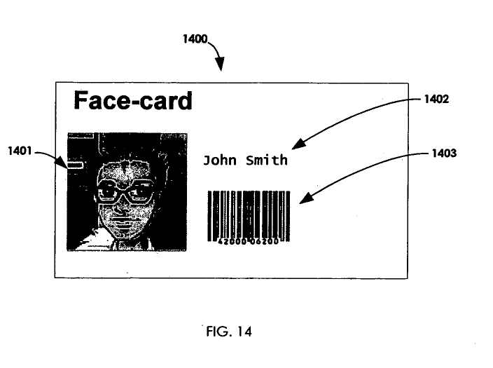

One embodiment of the present invention has a Real Persona Interactions Manager 208 that produces a graphical representation of the unique Face-key identifier suitable for printing on physical media and subsequent scanning from the physical media. One such embodiments employs a printed form of the face-key as a card with the Face-key identifier numerical value printed on it using a scannable graphical mark such as a barcode. Essentially, the Face-key is rendered as a face-card 1400 as depicted in FIG. 14. With this embodiment, a user can snail-mail a Face-card or present a face-card in person which is scanned by a recipient in order to view the associated persona links and Attributes. The Face-card's Face-key identifier may require logging in to the website associated with the Linked Personas Authenticator 100, but if the Face-key is associated with the UNIVERSAL group, it will not require any login to take place to view the associated Attributes. Any embodiment of the Face-card must have a graphic mark 1403, such as a barcode, for the unique Face-key identifier. Different embodiments may have or not have a photograph of the person 1401 and the name of the person 1402. While these identifying artifacts are normally required for identification in our society, these are not necessary with embodiments of the invention since a scan of the graphic mark 1403 can provide the photograph and name of the person over the Internet via a request to the Linked Personas Authenticator 100 website. Nevertheless, any quantity of Attributes may be printed on a Face-card for convenience. This remote centralization of authenticated real persona Attributes beneficially realizes higher confidence of true identity than a driver's license when presented in person since alteration of a Face-card will present Attributes that don't match the person who is present with the Face-card. Meanwhile, driver's licenses are fairly easy to alter and present in person with photo editing software and special paper.

One embodiment of the present invention recognizes the benefit of setting up a physical presence at various geographic locations or employing another entity at geographic locations to meet persons presenting their face-cards to verify their physical Attributes in person. In this case, the ReferencePersona link type is used by the entity to establish an authenticated link back to the same user account stored in the Linked Personas Authenticator 100. This provides further authentication of the physical Attributes that were previously declared and authenticated by the RealPersona authentication process.

One embodiment of the present invention provides the means for a user of the system to submit a persona link offer as opposed to a persona link request. This capability beneficially provides trusted sources cooperating with a Linked Personas Authenticator 100 website to facilitate establishing authenticated links to users and external accounts that the trusted source maintains. A persona link offer is distributed to a specific person's email from a trusted source via the Linked Personas Authenticator 100 website. A persona link offer represents a link to a persona that has already been authenticated by a trusted source and the trusted source is letting the person know that they may link to the persona because it is already authenticated. The persona link offer may also include authenticated Attributes. The Linked Personas Authenticator 100 website provides a user interface as well as a service (via HTTP or web service) in order to request distribution of a persona link offer to an email address which may also include Attributes.

When a trusted source requests distribution of a persona link offer, one embodiment inserts a User record to the Users table 307 exactly as was done for non-registered Users added for Face-key destinations where the isRegistered field is FALSE. The Link Request Manager 204 is augmented so that the PersonaLinks table 303 has a record inserted for the link where the personaType field is set to OFFER. When the persona link offer is sent, it comprises the PersonaLinkId of the PersonaLink table record 303 corresponding to the offer. The PersonaLinksAttributes table 304 and Attributes table 302 have records inserted for each Attribute that the trusted source declares as authenticated. When the registered user chooses to accept an email received persona link offer, they click the link on the persona link offer and must then login to accept the offer with a simple pushbutton. Acceptance causes the original User record to be deleted and the PersonaLink record with the persona link offer's personaLinkId to be reallocated to the accepting User record in the Users table 303. Reallocation involves overwriting the PersonaLink table 303 record userId field with the now linked userId. Additionally, the Attributes table 302 records corresponding to the deleted userId must also have their userId fields overwritten with the now linked userId. This completes the allocation of these records to User who accepted the persona link offer.

The present invention has been described in particular detail with respect to a limited number of embodiments. Those of skill in the art will appreciate that the invention may additionally be practiced in other embodiments. First, the particular naming of the components, capitalization of terms, the Attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A linked personas authenticator comprising:
a security manager for storing user accounts with unique user Id's and their associated passwords;
a link request manager for submitting outgoing requests for persona link authentication as well as correlating incoming persona link authentication responses;
a link request manager for storing link requests from a unique user Id to one or more unique persona identifiers;
a link request manager for storing authenticated links from a unique user Id to one or more unique persona identifiers;
an authentication process with a forward leg of the process that requires sending a message with a uniquely generated persona link identifier to an external trusted source such that the trusted source must forward this unique identifier to a user's persona wherein the user for the persona declared a unique address within the trusted source;
an authentication process with a reverse leg of the process that requires the same user that received the message with the uniquely generated persona link identifier to submit the unique identifier back to the linked persona authenticator using a means that proves that only a persona located at the unique persona identifier or address is the one that submitted it back in order to authenticate the link of the user id and unique persona identifier;
a key manager for submitting outgoing keys or messages comprising one or more links from an user id to a persona;
a user interface manager able to present and execute screens for users to configure and manage link authentication requests and the keys or messages comprising one or more links for user id to persona.

2. The linked personas authenticator system as recited in claim 1 further comprises a key manager for storing keys or messages comprising one or more links for user id to persona.

3. The linked personas authenticator system as recited in claim 1 further comprises an attribute manager that stores one or more pairs of names associated with values representing attributes of a user and associated screens within the user interface manager for creating and managing the attributes.

4. The linked personas authenticator as recited in claim 2 wherein the key manager further comprises:
the means to submit outgoing keys or messages comprising one or more links from an user id to a persona wherein each key may include a specific customized subset of the user's attributes;
the means to store the keys or messages comprising one or more authenticated links for user id to persona wherein each key may include a specific customized subset of the user's attributes.

5. The linked personas authenticator as recited in claim 4 wherein the key manager further includes the means to submit self-contained outgoing keys or messages that embed information comprising:
encrypted username and password pairs;
encrypted unique persona link identifiers;
encrypted Attributes.
executable instructions that run when the key message is opened by successful entry of a valid username and password which will then present the persona link identifiers and Attributes.

6. The linked personas authenticator as recited in claim 1 wherein the key manager further comprises:
the means to submit outgoing keys or messages comprising one or more links from an user id to a persona wherein the link has been authenticated already by a previously executed authentication process;
the means to store the keys or messages comprising one or more authenticated links for user id to persona wherein the link has been authenticated already by a previously executed authentication process.

7. The linked personas authenticator as recited in claim 1 wherein the key manager further comprises:
the means to submit non-self-contained outgoing keys or messages comprising only a single unique key identifier which is employed to look up the associated key information when a user logs in with the key identifier;
the means to store the keys or messages by a unique key identifier and associated with one or more authenticated links for user id to persona wherein each key may include a specific customized subset of the user's attributes.

8. The linked personas authenticator as recited in claim 1 wherein the key manager further comprises the means for users to set expiration dates and times for the privileges granted by the keys that they have created and distributed.

9. The linked personas authenticator as recited in claim 1 wherein the user interface manager provides the means for creating groups and the means for users to join them, and a Key may be created by each user for each specific group in order to control a specific subset of attributes that are searchable within the specified group.

10. The linked personas authenticator as recited in claim 1 wherein the authentication process authenticates links for user id to persona at a third-party trusted source within a specific expiration date and time, otherwise the authentication process response results in unsuccessful link authentication.

11. The linked personas authenticator as recited in claim 1 wherein the authentication process authenticates links for user id to electronic id at a third-party website trusted source comprising:
a forward leg of the process that requires logging onto the website and directly sending an electronic message via the website to the electronic id there wherein the message contains the unique persona identifier;
a reverse leg of the process that requires the same user that received the message with the uniquely generated persona link identifier to login to the link personas authenticator in order to enter the unique link identifier in order to authenticate the link of the user id and electronic id.

12. The linked personas authenticator system as recited in claim 1 further comprises a real persona interactions manager that transforms the persona link identifier numerical value into a graphical representation suitable for printing in a form that can be scanned later for transformation back into the original persona link identifier numerical value.

13. The linked personas authenticator system as recited in claim 1 further comprises a real persona interactions manager with personal barcode identifier page graphical representation creation ability suitable for printing wherein the personal barcode identifier page comprises graphical representation of a unique persona link identifier numerical value.

14. The linked personas authenticator as recited in claim 13 wherein the personal barcode identifier page further comprises a list of the name and value pairs of one or more of the attributes stored for a specified user.

15. The linked personas authenticator system as recited in claim 1 further comprises a real persona interactions manager with authentication page graphical representation creation ability suitable for printing wherein the authentication page contains a graphical representation of a unique persona link identifier numerical value and instructions including a snail-mail address to mail to.

16. The linked personas authenticator system as recited in claim 15 wherein the authentication page graphical representation creation ability further comprises the means to include an area on the page to affix a photograph.

17. The linked personas authenticator system as recited in claim 1 wherein the real persona interactions manager creation ability further comprises the means to create two pages of graphical representations suitable for printing of:
a personal barcode identifier page which contains a graphical representation of the unique persona link identifier numerical value which is suitable for scanning in later;
an authentication page which contains a graphical representation of the same unique persona link identifier numerical value, an area on the page to affix a photograph, and instructions including a snail-mail address to mail to.

18. The linked personas authenticator system as recited in claim 1 further comprises a snail-mail sender to assemble envelopes with the personal barcode identifier page and associated authentication page to be snail-mail sent to the user requesting real persona authentication process initiation;

19. The linked personas authenticator as recited in claim 1 further comprises a snail-mail receiver to open the snail-mail returned authentication page with graphical representation consisting of a photograph of the persona.

20. The linked personas authenticator system as recited in claim 1 further comprises a snail-mail receiver to scan the photograph and barcode into the linked personas authenticator software system.

21. The linked personas authenticator as recited in claim 15 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to insert the authentication page into a return envelope and snail-mail it back to the linked personas authenticator in order to authenticate the link of the user id and real persona.
a completion step wherein the snail-mail receiver scans in the returned authentication page so that the image can be stored associated with the persona link identifier numerical value represented by the barcode within the page image.

22. The linked personas authenticator as recited in claim 15 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to login to the link personas authenticator in order to enter the unique link identifier in order to authenticate the link of the user id and real persona.

23. The linked personas authenticator as recited in claim 16 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to take a photograph of themselves, affix the photograph to the authentication page, and insert the authentication page into a return envelope and snail-mail it back to the linked personas authenticator in order to authenticate the link of the user id and real persona as well as picture of the real persona.

24. The linked personas authenticator as recited in claim 16 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to take a digital photograph of themselves, login to the link personas authenticator in order to enter the unique link identifier as well as upload the digital photograph in order to authenticate the link of the user id and real persona as well as picture of the real persona.

25. The linked personas authenticator as recited in claim 16 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to take a photograph of themselves, affix the photograph to the authentication page, and insert the authentication page into a return envelope and snail-mail it back to the linked personas authenticator in order to authenticate the link of the user id and real persona as well as picture of the real persona.
a verification step wherein the snail-mail receiver scans in the returned authentication page so that the photograph barcode and separate personal barcode identifier barcode are recognized separately by the scanning software and compared for equivalence;
a completion step wherein the snail-mail receiver scans in the returned authentication page so that the image can be stored associated with the persona link identifier numerical value represented by the barcode within the page image.

26. The linked personas authenticator as recited in claim 17 wherein the authentication process authenticates links for user id to real persona living at a specific snail-mail address employing the postal service as a trusted source with high confidence comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to take a photograph of themselves with the personal barcode identifier page so that the barcode may be scanned from the photograph, affix the photograph to the authentication page, and insert the authentication page into a return envelope and snail-mail it back to the linked personas authenticator in order to highly authenticate the link of the user id and real persona as well as picture of the real persona.

27. The linked personas authenticator as recited in claim 26 wherein the authentication process authenticates a link for user id to real persona living at a specific snail-mail address employing the postal service as a trusted source with high confidence by further comprising the means to employ a mail delivery requiring a signature and then collecting the received signature notification from the postal service for entry into the linked persona authenticator information database.

28. The linked personas authenticator as recited in claim 26 wherein the authentication process authenticates a link for user id to real persona living at a specific snail-mail address employing the postal service as a trusted source with very high confidence by further comprising the means to repeat the authentication process periodically at a frequency.

29. The linked personas authenticator as recited in claim 7 further comprises the means to print a card with a single graphical mark representing the numerical value of a unique key identifier that may be given or presented by a user for subsequent scanning and for which operationally is the same as an electronic key identifier.

30. The linked personas authenticator as recited in claim 7 wherein the link request manager further comprises the means to
submit an outgoing persona link offer for link authentication;
add an accepted persona link offer to a user's list of linked personas;
correlate incoming persona link offer acceptances.

31. The linked personas authenticator as recited in claim 30 wherein the link request manager further comprises the means to:
associate zero or more attributes to the persona link offer;
add authenticated attributes in an accepted persona link offer to a user's list of attributes.

32. A method for authenticating links between multiple personas:
providing secure storage of user accounts with unique user Id's and their associated passwords;
providing the ability to submit outgoing requests for persona link authentication as well as correlating incoming persona link authentication responses;
providing the ability to store link requests from a unique user Id to one or more unique persona identifiers;
providing the ability to store authenticated links from a unique user Id to one or more unique persona identifiers;
providing interaction with an authentication process with a forward leg of the process that requires sending a message with a uniquely generated persona link identifier to an external trusted source such that the trusted source must forward this unique identifier to a user's persona wherein the user for the persona declared a unique address within the trusted source;
providing interaction with an authentication process with a reverse leg of the process that requires the same user that received the message with the uniquely generated persona link identifier to submit the unique identifier back to the linked persona authenticator using a means that proves that only a persona located at the unique persona identifier or address is the one that submitted it back in order to authenticate the link of the user id and unique persona identifier;
providing the ability to submit outgoing keys or messages comprising one or more links from an user id to a persona;
providing a user interface to present and execute screens for users to configure and manage link authentication requests and the keys or messages comprising one or more links for user id to persona.

33. The method as recited in claim 32 further provides the ability to store keys or messages comprising one or more links for user id to persona.

34. The method as recited in claim 32 further provides attribute management with the ability to store one or more pairs of names associated with values representing attributes of a user and associated screens within the user interface for creating and managing the attributes.

35. The method as recited in claim 33 further provides:
the means to submit outgoing keys or messages comprising one or more links from an user id to a persona wherein each key may include a specific customized subset of the user's attributes;
the means to store the keys or messages comprising one or more authenticated links for user id to persona wherein each key may include a specific customized subset of the user's attributes.

36. The method as recited in claim 35 the means to submit self-contained outgoing keys or messages that embed information comprising:
encrypted username and password pairs;
encrypted unique persona link identifiers;
encrypted Attributes.
executable instructions that run when the key message is opened by successful entry of a valid username and password which will then present the persona link identifiers and Attributes.

37. The method as recited in claim 32 further provides:
the means to submit outgoing keys or messages comprising one or more links from an user id to a persona wherein the link has been authenticated already by a previously executed authentication process;
the means to store the keys or messages comprising one or more authenticated links for user id to persona wherein the link has been authenticated already by a previously executed authentication process.

38. The method as recited in claim 32 further comprises:
the means to submit non-self-contained outgoing keys or messages comprising only a single unique key identifier which is employed to look up the associated key information when a user logs in with the key identifier;
the means to store the keys or messages by a unique key identifier and associated with one or more authenticated links for user id to persona wherein each key may include a specific customized subset of the user's attributes.

39. The method as recited in claim 32 further comprises the means for users to set expiration dates and times for the privileges granted by the keys that they have created and distributed.

40. The method as recited in claim 32 wherein the user interface provides the means for creating groups and the means for users to join them, and a key may be created by each user for each specific group in order to control a specific subset of attributes that are searchable within the specified group.

41. The method as recited in claim 32 wherein the authentication process authenticates links for user id to persona at a third-party trusted source within a specific expiration date and time, otherwise the authentication process response results in unsuccessful link authentication.

42. The method as recited in claim 32 wherein the authentication process authenticates links for user id to electronic id at a third-party website trusted source comprising:
a forward leg of the process that requires logging onto the website and directly sending an electronic message via the website to the electronic id there wherein the message contains the unique persona identifier;
a reverse leg of the process that requires the same user that received the message with the uniquely generated persona link identifier to login to the link personas authenticator in order to enter the unique link identifier in order to authenticate the link of the user id and electronic id.

43. The method as recited in claim 32 further comprises the ability to transform the persona link identifier numerical value into a graphical representation suitable for printing in a form that can be scanned later for transformation back into the original persona link identifier numerical value.

44. The method as recited in claim 32 further comprises the ability to create a personal barcode identifier page graphical representation which is suitable for printing wherein the personal barcode identifier page comprises graphical representation of a unique persona link identifier numerical value.

45. The method as recited in claim 44 further comprises the ability to create the personal barcode identifier page with a list of the name and value pairs of one or more of the attributes stored for a specified user.

46. The method as recited in claim 32 further comprises the ability to create an authentication page graphical representation which is suitable for printing wherein the authentication page contains a graphical representation of a unique persona link identifier numerical value and instructions including a snail-mail address to mail to.

47. The method as recited in claim 46 further comprises the ability to create an authentication page graphical representation with an area on the page to affix a photograph.

48. The method as recited in claim 32 further comprises the ability to create two pages of graphical representations suitable for printing of:
a personal barcode identifier page which contains a graphical representation of the unique persona link identifier numerical value which is suitable for scanning in later;
an authentication page which contains a graphical representation of the same unique persona link identifier numerical value, an area on the page to affix a photograph, and instructions including a snail-mail address to mail to.

49. The method as recited in claim 32 further comprises the ability to send snail-mail by assembling envelopes with the personal barcode identifier page and associated authentication page be snail-mail sent to the user requesting real persona authentication process initiation.

50. The method as recited in claim 32 further comprises the ability to receive snail-mail and to open the snail-mail returned authentication page with graphical representation consisting of a photograph of the persona.

51. The method as recited in claim 32 further comprises the ability to receive snail-mail and to scan the photograph and barcode into the linked personas authenticator software system.

52. The method as recited in claim 46 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to insert the authentication page into a return envelope and snail-mail it back to the linked personas authenticator in order to authenticate the link of the user id and real persona.
a completion step wherein the snail-mail receiver scans in the returned authentication page so that the image can be stored associated with the persona link identifier numerical value represented by the barcode within the page image.

53. The method as recited in claim 46 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the some user that received the snail-mailed envelope with the uniquely generated persona link identifier printed on the authentication page to login to the link personas authenticator in order to enter the unique link identifier in order to authenticate the link of the user id and real persona.

54. The method as recited in claim 47 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to take a photograph of themselves, affix the photograph to the authentication page, and insert the authentication page into a return envelope and snail-mail it back to the linked personas authenticator in order to authenticate the link of the user id and real persona as well as picture of the real persona.

55. The method as recited in claim 47 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to take a digital photograph of themselves, login to the link personas authenticator in order to enter the unique link identifier as well as upload the digital photograph in order to authenticate the link of the user id and real persona as well as picture of the real persona.

56. The method as recited in claim 47 wherein the authentication process authenticates links for user id to real persona living at a specific snail-mail address employing the postal service as a trusted source comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to take a photograph of themselves, affix the photograph to the authentication page, and insert the authentication page into a return envelope and snail-mail it back to the linked personas authenticator in order to authenticate the link of the user id and real persona as well as picture of the real persona.
a verification step wherein the snail-mail receiver scans in the returned authentication page so that the photograph barcode and separate personal barcode identifier barcode are recognized separately by the scanning software and compared for equivalence;
a completion step wherein the snail-mail receiver scans in the returned authentication page so that the image can be stored associated with the persona link identifier numerical value represented by the barcode within the page image.

57. The method as recited in claim 48 wherein the authentication process authenticates links for user id to real persona living at a specific snail-mail address employing the postal service as a trusted source with high confidence comprising:
a forward leg of the process that requires printing an authentication page containing a graphical representation of the unique persona link identifier, inserting it into an envelope and snail-mailing it to the real persona's declared snail-mail address;
a reverse leg of the process that requires the same user that received the snail-mailed envelope with the uniquely generated persona link identifier printed on the authentication page to take a photograph of themselves with the personal barcode identifier page so that the barcode may be scanned from the photograph, affix the photograph to the authentication page, and insert the authentication page into a return envelope and snail-mail it back to the linked personas authenticator in order to highly authenticate the link of the user id and real persona as well as picture of the real persona.

58. The method as recited in claim 57 further comprises the ability to authenticate a link for user id to real persona living at a specific snail-mail address employing the postal service as a trusted source with high confidence by further comprising the means to employ a mail delivery requiring a signature and then collecting the received signature notification from the postal service for entry into the linked persona authenticator information database.

59. The method as recited in claim 57 further comprises the ability to authenticate a link for user id to real persona living at a specific snail-mail address employing the postal service as a trusted source with very high confidence by further comprising the means to repeat the authentication process periodically at a frequency.

60. The method as recited in claim 38 further comprises the ability to print a card with a single graphical mark representing the numerical value of a unique key identifier that may be given or presented by a user for subsequent scanning and for which operationally is the same as an electronic key identifier.

61. The method as recited in claim 38 further comprises the means to submit an outgoing persona link offer for link authentication;
add an accepted persona link offer to a user's list of linked personas;
correlate incoming persona link offer acceptances.

62. The method as recited in claim 61 wherein the link request manager further comprises the means to:
associate zero or more attributes to the persona link offer;
add authenticated attributes in an accepted persona link offer to a user's list of attributes.
